(19) United States
(12) Patent Application Publication
(10) Pub. No.: US 2014/0158631 A1
(43) Pub. Date: Jun. 12, 2014

(54) SEPARATION OF NEUTRALLY BUOYANT MATERIALS FROM WATER

(71) Applicant: ADVANCED WATER RECOVERY, LLC, Rapid City, SD (US)

(72) Inventors: Rakesh Govind, Cincinnati, OH (US); Robert Foster, Calgary (CA)

(73) Assignee: ADVANCED WATER RECOVERY, LLC, Rapid City, SD (US)

(21) Appl. No.: 14/099,237

(22) Filed: Dec. 6, 2013

Related U.S. Application Data
(60) Provisional application No. 61/786,972, filed on Mar. 15, 2013.
(60) Provisional application No. 61/735,211, filed on Dec. 10, 2012.
(60) Provisional application No. 61/734,491, filed on Dec. 7, 2012.

(51) Int. Cl. C02F 1/24; B01D 17/02

(52) U.S. Cl. CPC C02F 1/24; B01D 17/0205
USPC 210/706; 210/703; 210/209; 252/60

(57) ABSTRACT

Described herein are methods of separating phase separated, neutrally buoyant materials from liquids and apparatuses for carrying out the methods. The methods and apparatuses employ nanobubbles. In certain embodiments, the nanobubbles may be formed in solutions of hydrophobically modified water soluble polymers. The methods result in removal of 90% by weight or more of neutrally buoyant materials from liquids. The methods are useful in certain embodiments for separating neutrally buoyant oily mixtures from water produced by mining operations.

### CROSS-REFERENCE TO RELATED APPLICATIONS

This application claims the benefit of the filing dates of U.S. Patent Application No. 61/786,972, entitled “Flotation of Neutrally Buoyant Materials in Water,” filed on Mar. 15, 2013; U.S. Patent Application No. 61/735,211, entitled “Process for Converting Brackish/Produced Water to Useful Products and Reusable Water,” filed on Dec. 10, 2012; and U.S. Patent Application No. 61/734,491, entitled “Process for Converting Brackish/Produced Water to Useful Products and Reusable Water”, filed on Dec. 7, 2012, the disclosures of which are incorporated by reference herein in their entireties.

### FIELD OF THE INVENTION

Aspects of the present invention generally relate to methods of separating materials from a liquid, and particularly relate to separating neutrally buoyant materials from a liquid such as contaminated water (e.g., brackish or produced water).

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Subsurface geological operations such as mineral mining, oil well drilling, natural gas exploration, and induced hydraulic fracturing generate wastewater contaminated with significant concentrations of impurities. These impurities vary widely in both type and amount depending on the type of geological operation, the nature of the subsurface environment, and the type and amount of soluble minerals present in the native water source. The contaminated water is eventually discharged into surface waters or sub-surface aquifers. In some cases, wastewater generated from drilling and mining operations have resulted in making regional water supplies unusable. Induced hydraulic fracturing (a.k.a. hydro fracturing, or fracking) in particular is a highly water-intensive process, employing water pumped at pressures exceeding 3,000 psi and flow rates exceeding 85 gallons per minute to create fractures in subsurface rock layers. These created fractures intersect with natural fractures, thereby creating a network of flow channels to a well bore. These flow channels allow the release of petroleum and natural gas products for extraction. The flow channels also allow the injected water plus additional native water to flow to the surface along with the fuel products once the fractures are created.

Flowback water, and produced water, from subsurface geological operations contains a variety of contaminants. Often, produced water is “hard” or brackish and further includes dissolved or dispersed organic and inorganic materials. Produced water can include chemicals used in the mining operation, such as hydrocarbons that are injected along with water to facilitate fracture formation in hydrofracturing. One common type of contaminant present in produced water from hydrofracturing is a mixture of free and emulsified oil together with gel-like accumulations of hydrocarbons. In most cases, this oily mixture further contains silt, sand, and/or clay particulates gathered by the produced water as it travels to the surface. These oily mixtures are neutrally buoyant—that is, they neither sink nor float, or they require extended times to sink or float—in produced water. While in some cases these oily mixtures are visible as agglomerated, black, and tarry-looking residues, in other cases the oily mixtures, or some portion thereof, are finely divided dispersed liquids or liquid/solid droplets or particles present throughout the water phase.

Conventional oil separation processes relying on density differences are incapable of effectively separating this oily mixture from produced water, since their densities are very close. Conventional filtering methods employ screen or filter media that are quickly clogged by the oily mixture. Gravity separation is not only slow but also requires the use of large tanks and low flow rates in order to provide the long residence times needed to achieve an effective separation. Even with very long residence times, very well dispersed, fine oily mixture droplets are sometimes inseparable from the water phase. Methods such as evaporation of water from the mixture are not only time intensive, but highly energy intensive as well, and impractical for mining operations where large volumes of produced water are generated in short periods of time. Thus, current processes for removing such material suffer many drawbacks.

Further remediation of produced water is only possible once this oily mixture is removed. Therefore, there is a need for a process for effectively removing neutrally buoyant materials from water. For example, in the mining industry, there is a need for a process to effectively remove an oily mixture from produced water in an efficient manner to result in produced water that is substantially free of emulsified petroleum, sand, silt, clay, and gel-like hydrocarbons. There is a need to remove neutrally buoyant materials other than such oily mixtures from water. There is a need for these processes to operate without undue energy expenditure. There is a need for these processes to operate at a rate that is commensurate with water-intensive applications such as hydrofracturing. In certain applications, there is a need for these processes to operate using materials and equipment suitably and conveniently employed on site in a mining operation.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

One aspect of the present invention includes methods of separating a neutrally buoyant material or materials from a liquid. As described above, particles or phases which have a lower density than the liquid they are in will move to the surface of the liquid on their own (i.e., float), and particles or phases with densities greater than the liquid will move towards the bottom of the liquid (i.e., settle). The challenge is in removing particles or phases which have a density close to the liquid they are in—i.e., which are neutrally buoyant or nearly neutrally buoyant—and which otherwise on their own would take a long time to either settle or float. One method for accomplishing this is described herein. The method includes pressurizing a first liquid with a gas at a first pressure to form a pressurized liquid, and then contacting the pressurized liquid with a second liquid including a neutrally buoyant material dispersed therein. In this method, the second liquid is maintained at a second pressure that is lower than the first pressure, and the contacting of the pressurized liquid to second liquid includes a gradient pressure change from the first pressure to the second pressure. This gradient pressure change results in the formation of nanobubbles within at least the second liquid. Such nanobubbles may have an average diameter of about 10 nm to 100 nm. The neutrally buoyant material or materials are then separated from the second liquid by association of these bubbles (such as air bubbles) with the neutrally buoyant materials (via attachment or otherwise). For example, such association may occur via hydrogen bonding between an alcohol group and a water molecule. (These and other types of associations are well known to those of ordinary skill in the art.) By virtue of the bubbles' density difference with the second liquid (e.g. water), these neutrally buoyant materials (e.g. particles or phases) are moved to the surface of the second liquid (e.g. water), where they can be skimmed off. In other words, the combined density of the bubble and neutrally buoyant material is sufficient to move in the direction of the surface.

The formation of nanobubbles is described above as occurring within at least the second liquid. This can be accomplished by contacting the first liquid with the second liquid such that, while a portion of the first and second liquids may be combined, the nanobubbles rise through the second liquid (i.e., a portion of the second liquid that is not combined, or is yet to be combined, with the first liquid). Alternatively, or additionally, the nanobubbles may form and rise within the combined first and second liquids.

In some embodiments, the first liquid is water. And, in certain embodiments, the first liquid may include a hydrophobically modified water soluble polymer dispersed or dissolved therein. In some such embodiments, the hydrophobically modified water soluble polymer may include repeat units attributable to monomers including acrylamide, acrylate, methacrylate, or combinations thereof.

In some embodiments, the second liquid is water. In certain embodiments, the water further includes one or more solids dissolved therein. In some such embodiments, the water is hard water, brackish water, or produced water. In some embodiments the neutrally buoyant material is oil or an oily mixture. In some embodiments, the pressure difference between the first pressure and the second pressure is about 0.1 MPa to 1 MPa. In some embodiments, the second pressure is ambient pressure, or 1 atm (0.101 MPa). The separation includes flotation of the neutrally buoyant material to the surface of the liquid. In certain embodiments, the method is effective for separating at least 90 wt % to 100 wt % of the total weight of neutrally buoyant material from the liquid, or about 93 wt % to 99.9 wt %, or about 95 wt % to 99 wt % by weight of the neutrally buoyant material from the liquid. The method further includes, in some embodiments, removing the separated neutrally buoyant material from the surface of the combined first and second liquid.

Another aspect of the invention includes methods of forming nanobubbles, the method including dissolving a hydrophobically modified water soluble polymer in water to form a solution, pressurizing the solution with a gas or mixture of gases at elevated pressure to form a pressurized solution, and reducing the pressure applied to the pressurized solution employing a gradient pressure change sufficient to form nanobubbles, the nanobubbles having an average diameter of between about 10 nm and 100 nm. In this aspect, the hydrophobically modified water soluble polymer may be associated with the nanobubbles.

Yet another aspect of the invention includes apparatus that achieve separation and removal of a neutrally buoyant material or materials from liquid. Such apparatus may include a source of pressurized gas; a pressurized tank situated to receive a pressurized solution of a first liquid, the pressurized tank connected to the source of pressurized gas; an element attached to the pressurized tank and disposed to deliver the pressurized solution into a second liquid; a receiving vessel for holding a second liquid having a neutrally buoyant material dispersed therein, wherein the element is disposed within the receiving vessel. The apparatus may further include a skimmer disposed within the receiving vessel and situated to remove a separated layer (including the neutrally buoyant material) from the surface of liquid present within the receiving vessel. The first liquid may be water. The first liquid may include a hydrophobically modified water soluble polymer. The element for delivering the pressurized solution may include one or more headers and/or one or more eductors. The apparatus is useful for achieving separation and removal of neutrally buoyant materials from a liquid, employing the methods described above.

The methods of separation and apparatuses employed to separate the neutrally buoyant materials from liquids are useful in a number of applications. Remediation of water from mining operations is one such application. Treatment of seawater is another. Others include separating living biomaterials from a bioreactor tank, or sequestration of carbon dioxide from power plants.

Additional advantages and novel features of the invention will be set forth in part in the description that follows, and in part will become apparent to those skilled in the art upon examination of the following, or may be learned through routine experimentation upon practice of the invention.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic showing a nanobubble formed in the presence of a hydrophobically modified water soluble polymer, in accordance with the principles of the present invention.

FIG. 2 is a schematic and table demonstrating the principle of the Young-Laplace equation.

FIG. 3 is a chart showing the larger surface area provided for contact with neutrally buoyant materials as bubbles get smaller.

FIG. 4 is a schematic of an apparatus employed to carry out the invention.

FIG. 5 and FIG. 5A are a schematic of an embodiment of a nozzle wherein the water and air are introduced tangentially and the nanobubbles and water exit from the narrow section of the nozzle, and a cross-section of same.

FIG. 6 is a schematic representation of a hydrophobically modified polymer and its attachment to nanobubbles, for the use thereof.

FIG. 7 is a schematic representation of a hydrophobically modified polymer and its attachment to nanobubbles, for the use thereof.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Further, various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As described above, one aspect of the present invention includes methods of separating a neutrally buoyant material or materials from a liquid. As described above, particles or phases which have a lower density than the liquid they are in will move to the surface of the liquid on their own (i.e., float), and particles or phases with densities greater than the liquid will move towards the bottom of the liquid (i.e., settle). The challenge is in removing particles or phases which have a density close to the liquid they are in—i.e., which are neutrally buoyant or nearly neutrally buoyant—and which otherwise on their own would take a long time to either settle or float. Methods for accomplishing this are described herein. An example of one such method includes pressurizing a first liquid with a gas at a first pressure to form a pressurized liquid, and then contacting the pressurized liquid with a second liquid including a neutrally buoyant material dispersed therein. In this method, the second liquid may be maintained at a second pressure that is lower than the first pressure, and the contacting of the pressurized liquid to second liquid may include a gradient pressure change from the first pressure to the second pressure. This gradient pressure change results in the formation of nanobubbles within at least the second liquid. Such nanobubbles may have an average diameter of about 10 nm to 100 nm. The neutrally buoyant material or materials are then separated from the second liquid by association of these bubbles (such as air bubbles) with the neutrally buoyant materials (via attachment or otherwise). For example, such association may occur via hydrogen bonding between an alcohol group and a water molecule. By virtue of the bubbles' density difference with the second liquid (e.g. water), these neutrally buoyant materials (e.g. particles or phases) are moved to the surface of the second liquid (e.g. water), where they can be skimmed off.

The formation of nanobubbles is described above as occurring within at least the second liquid. This can be accomplished by contacting the first liquid with the second liquid such that, while a portion of the first and second liquids may be combined, the nanobubbles rise through the second liquid (i.e., a portion of the second liquid that is not combined, or is yet to be combined, with the first liquid). Alternatively, or additionally, the nanobubbles may form and rise within the combined first and second liquids.

In some embodiments, the first liquid is water. And, in certain embodiments, the first liquid may include a hydrophobically modified water soluble polymer dispersed or dissolved therein. In some such embodiments, the hydrophobically modified water soluble polymer may include repeat units attributable to monomers including acrylamide, acrylate, methacrylate, or combinations thereof.

In some embodiments, the second liquid is water. In certain embodiments, the water further includes one or more solids dissolved therein. In some such embodiments, the water is hard water, brackish water, or produced water. In some embodiments the neutrally buoyant material is oil or an oily mixture. In some embodiments, the pressure difference between the first pressure and the second pressure is about 0.1 MPa to 1 MPa. In some embodiments, the second pressure is ambient pressure, or 1 atm (0.101 MPa). The separation includes flotation of the neutrally buoyant material to the surface of the liquid. In certain embodiments, the method is effective for separating at least 90 wt % to 100 wt % of the total weight of neutrally buoyant material from the liquid, or about 93 wt % to 99.9 wt %, or about 95 wt % to 99 wt % by weight of the neutrally buoyant material from the liquid. The method further includes, in some embodiments, removing the separated neutrally buoyant material from the surface of the combined first and second liquid.

Another aspect of the invention includes methods of forming nanobubbles, the method including pressurizing the solution with a gas or mixture of gases at elevated pressure to form a pressurized solution, and reducing the pressure applied to the pressurized solution employing a gradient pressure change sufficient to form nanobubbles, the nanobubbles having an average diameter of between about 10 nm and 100 nm.

Another aspect of the invention includes methods of forming nanobubbles, the method including dissolving a hydrophobically modified water soluble polymer in water to form a solution, pressurizing the solution with a gas or mixture of gases at elevated pressure to form a pressurized solution, and reducing the pressure applied to the pressurized solution employing a gradient pressure change sufficient to form nanobubbles, the nanobubbles having an average diameter of between about 10 nm and 100 nm. In this aspect, the hydrophobically modified water soluble polymer may be associated with the nanobubbles.

Yet another aspect of the invention includes apparatus that separate and remove a neutrally buoyant material or materials from liquid. Such apparatus may include (1) a source of pressurized gas; (2) a pressurized tank situated to receive a pressurized solution of a first liquid, with the pressurized tank being connected to the source of pressurized gas; (3) an element attached to the pressurized tank and disposed to deliver the pressurized solution into a second liquid; and (4) a receiving vessel for holding a second liquid having a neutrally buoyant material dispersed therein. The element is disposed within the receiving vessel. The apparatus may further include a skimmer disposed within the receiving vessel and situated to remove a separated layer (including the neutrally buoyant material) from the surface of liquid present within the receiving vessel. The first liquid may include a hydrophobically modified water soluble polymer. The element for delivering the pressurized solution may include one or more headers and/or one or more eductors. The apparatus is useful for achieving separation and removal of neutrally buoyant materials from a liquid, employing the methods described above.

### 1. DEFINITIONS

As used herein, the term “water” means pure water, water with some mineral content, water with some organic content, hard water, or brackish water; or combinations of these. As used herein, the term “hard water” means water having at least about 30 mg/L, in some cases as much as about 25,000 mg/L, of CaCO₃ dissolved therein. In some cases the hard water has other ionic compounds dissolved or dispersed therein, and/or other materials dissolved or dispersed therein. As used herein, the term “brackish water” means water having at least about 400 mg/L, in some cases as much as about 80,000 mg/L, of sodium, present as NaCl, dissolved therein. In some cases the brackish water has other ionic compounds dissolved or dispersed therein, and/or other materials dissolved or dispersed therein.

As used herein, the term “produced water” means leachates, flow back, or surface water obtained as the result of, or contaminated with the byproducts of, a subsurface geological operation. In some embodiments the produced water is hard water or brackish water. In some embodiments the subsurface geological operation is hydrofracturing.

Herein, methods and apparatus will be described for the separation of materials, such as neutrally buoyant materials, from water. At times, this water may be referred to as “hard” water, or “brackish” water, or “produced” water, or another type of water (which may even include waters not subjected to subsurface geological operations, such as seawater). However, those of ordinary skill in the art will recognize that the methods and apparatus described do not have to be seen as only used with the particular type of water mentioned (whether “wastewater,” “produced,” “hard,” “brackish,” “flowback,” “contaminated,” etc.), but with any water from any source containing a material or materials that one wishes to remove.

As used herein, the term “neutrally buoyant material” means a solid or liquid material in a liquid (and may be a solid or liquid phase material that is phase separated in a liquid), and wherein spontaneous flotation or sinking of the material either does not occur at temperatures near 25° C., or occurs over a period of more than about 20 minutes. In some embodiments, the neutrally buoyant material has an average density that is between about 95% and 105% of the density of the surrounding liquid. The neutrally buoyant material may be, in various embodiments, dispersed, emulsified, gelled, or agglomerated within the liquid; or combinations thereof. In various embodiments, the neutrally buoyant material may be a single compound, a range of related compounds, or a heterogeneous mixture of compounds. The neutrally buoyant material may include a single phase or multiple phases, such as a mixture of a solid and a gel, or a solid and an emulsified liquid particulate, and the like. In some embodiments, the neutrally buoyant material may be an oily mixture. It will be understood by those skilled in the art that the use of “neutrally buoyant” herein refers to materials that are neutrally buoyant, and to materials that are nearly neutrally buoyant. Further, it will be understood by those skilled in the art that a reference to a neutrally buoyant “material” in a liquid may encompass a single such material, or multiple materials.

As used herein, the term “oily mixture” means a mixture that includes one or more chemicals used in a mining operation, one or more surfactants, one or more petroleum products such as oil, emulsified petroleum products, gel-like accumulations of hydrocarbons and/or petroleum products, one or more particulates including silt, sand, or clay, or a combination of two or more thereof.

As used herein, the term “gas” means a substance that is present as a gas at temperatures at or above a temperature of 0° C. to 20° C., at or above a pressure of 0.2 MPa to 1 MPa, or both. “Gas” may include both single chemical compounds or elements, or mixtures of two or more compounds or elements. Air is an example of a gas, wherein air includes a mixture of oxygen, nitrogen, carbon dioxide, and many trace compounds and elements; varying levels of water vapor are often included in air.

As used herein, the term “first liquid” means the liquid in which gas is dissolved. The gas may be dissolved by applying a first pressure of the gas to the liquid in order to dissolve some amount of gas therein. The liquid may be a single compound, such as water, or a mixture of different compounds, such as an aqueous solution of an alcohol, or a solution of a hydrophobically modified water soluble polymer in water. As used herein, the “second liquid” means a liquid that includes a neutrally buoyant material. The second liquid may be maintained at a second pressure that is less than the first pressure.

As used herein, the term “nanobubbles” means bubbles of a gas within a liquid, wherein the bubbles having an average diameter of about 10 nm to 100 nm and have a density that is 90% or less of the density of the liquid.

As used herein, the term “hydrophobically modified water soluble polymer” or “HMP” means a polymer having a majority by weight of content that is dispersible or dissolvable in water, and about 0.01 wt % to about 5 wt %, based on the dry weight of the polymer, of hydrophobic moieties covalently bonded to and pendant from, incorporated within, or present at the termini of the polymer backbone. When discussing mixtures of HMP in water, the terms “soluble” or “solution” indicate either a solution or dispersion of polymer in water, as those terms of art are employed.

As used herein, the term “hydrophobic moieties” means moieties that exhibit a tendency to aggregate in water (such as pure water, hard water, and/or brackish water) and exclude water molecules. In some cases, hydrophobic moieties are nonpolar, such as linear alkane moieties. In various embodiments, hydrophobic moieties include hydrocarbon, siloxane, or fluorocarbon content or a combination thereof.

As used herein, the term “elevated pressure” means any pressure in excess of atmospheric pressure. As used herein, the term “ambient pressure” means inherent pressure upon equilibration with atmospheric pressure, that is, 0.101 MPa or 1 atm.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the term “optional” or “optionally” means that the subsequently described event or circumstance may occur, but need not occur, and that the description includes instances where the event or circumstance occurs and instances in which it does not.

### 2. FORMATION OF NANOBUBBLES

As described above, one aspect of the present invention includes methods for separating neutrally buoyant materials from a liquid via the use of bubbles (such as air bubbles). Methods for generating small bubbles in water typically include the use of one or more of nozzles, membranes, porous tubes, venturis, and the like, wherein a mixture of air and water is mixed in a moving system. These methods rely on kinetic and/or pressure energy to divide the air flow into the water phase. However, unless a significant amount of energy is expended in a small flow of air, it is difficult to form nanobubbles. This is principally due to the fact that the air/water interface has a high surface tension, and therefore it takes considerable energy to produce a high air/water surface area, usually requiring ultrasonic or high acoustic energy dissipation. For example, in a typical nanobubble generation system, the water and the air have to be mixed and released at considerable flow pressures in order to form small bubbles. At lesser pressures, the air bubbles formed are much bigger in size, and hence do not have the high gas-liquid surface contact area that is desirable. And, at the higher pressures required to decrease bubble size to form nanobubbles, much energy is required, which is undesirable.

For example, U.S. Patent Application Publication No. 2007/0108640, is an example of the consumption of high energy to form small bubbles. In the '640 application, Takahashi et al. claim a device which first dissolves air under pressure and then draws, using suction through a mixer unit, the dissolved air-enriched-water and a stream of air, using a nozzle. The dissolved air-enriched-water becomes supersaturated and requires less pressurization overall and thus the air forms microbubbles. In U.S. Patent Application Publication No. 2007/0119987, Vion demonstrates a three-staged compression system with a pre-release stage with modest decompression, a nozzle release stage and a transition chamber which brings the pressure to saturation, before a final outlet tube which confines cavitation and limits the reattachment of the bubble to the tube walls, thus preventing coalescence of the bubbles into a larger bubble. This also requires an undesirable amount of energy.

In certain embodiments of the invention, nanobubbles are generated by pressurizing a liquid with a gas to dissolve some portion of the gas in the liquid, then reducing the pressure to form bubbles as the dissolved gas or gaseous mixture comes out of solution. By reducing the pressure in a gradient or stepwise fashion, bubbles are formed having decreased average diameter compared to bubbles that form when pressure is changed in a single step. Thus, by carefully controlling the gradient pressure change, bubbles can be formed having an average diameter of 100 nm or less, for example between 10 nm and 100 nm. And, the methods and apparatus described herein achieve these nanobubbles without the high expenditure of energy seen in the prior art.

Further, in some embodiments the pressurized liquid is water, the gas is air, and the water includes hydrophobically modified water soluble polymers dissolved therein. The presence of the hydrophobically modified water soluble polymers increases the solubility of air in water, and enhances the formation/stability of nanobubbles, as will be described in greater detail below.

The nanobubbles are useful in separating neutrally buoyant materials from liquids, by causing efficient flotation of the neutrally buoyant materials. The nanobubbles, which for a given volume of gas provide a higher gas-liquid interfacial area compared to conventional bubbles, provide for a high efficiency of flotation due to enhanced degree of contact between the neutrally buoyant materials and the buoyant gas bubbles.

In certain embodiments, the gaseous mixture employed to form the nanobubbles is air. Ambient or atmospheric air is comprised principally of a characteristic mixture of nitrogen and oxygen, along with various trace compounds and elements such as argon, neon, carbon dioxide, methane, and the like. Table 1 shows the amount of dry ambient air that may be dissolved in plain water at 25° C. Ambient pressure, that is, 0.10 MPa (1 atm), results in deionized-distilled water having about 0.023 g of air dissolved per kilogram of plain water. And, about 5.9 times more air can be dissolved at 0.61 MPa (6 atm), compared to the amount that is dissolved at 0.10 MPa.

TABLE 1
Amount of ambient air dissolved in deionized-
distilled water over a range of pressures.

| Pressure (atm) | 1 | 2 | 3 | 4 | 5 | 6 |
|---|---|---|---|---|---|---|
| Pressure (MPa) | 0.10 | 0.20 | 0.30 | 0.41 | 0.51 | 0.61 |
| Amount of Air Dissolved | 0.023 | 0.045 | 0.068 | 0.091 | 0.114 | 0.136 |
| (g/kg H2O, 25° C.) | | | | | | |

While Table 1 describes air as being the gas dissolved in the first liquid, the gas does not have to be air. Useful gases and gaseous mixtures employed to form nanobubbles using various methods include, but are not limited to, carbon dioxide (CO₂), nitrogen (N₂), helium (He), argon (Ar), air enriched with N₂, CO₂, oxygen (O₂), He, and/or Ar, and the like. It will be appreciated that various gases and gaseous mixtures have different densities at a particular temperature, and these density differences lead to varying inherent rates of flotation when nanobubbles are formed in water (or other liquid), as will be recognized by those of ordinary skill in the art. Additionally, in some embodiments, the chemical makeup of the gas or gaseous mixture is useful for facilitating, or maximizing yield of, a desired chemical reaction or set of reactions; or in other embodiments, the chemical makeup of the gas or gaseous mixture is useful for preventing, or minimizing yield of, one or more undesirable chemical reactions. For example, in some embodiments it may be useful to prevent oxidation of chemical species present in the water; in such embodiments, it is desirable to exclude oxygen from the gaseous mixture and provide, for example, nitrogen or carbon dioxide in place of air or another mixture containing O₂.

It has been determined by the present inventors that, in the presence of hydrophobically modified polymers (or HMP), greater amounts of air can be dissolved in water at the same pressures, as compared to the amount of air that can be dissolved without the HMP. This in turn leads to a greater yield of nanobubbles per unit volume of water when the pressure is reduced. Additionally, the present inventors have determined that the presence of HMP leads to stabilized nanobubbles. By stabilized, it is meant that the nanobubbles appear to resist consolidation and popping (especially as compared to nanobubbles that are formed without the presence of HMP, although nanobubbles that are formed without the presence of HMP may still be useful in separating neutrally-buoyant materials and are used in certain embodiments of the present invention). While the observation of increased stability is consistent with observations of conventional bubbles in the presence of HMP, the stabilization effect is unexpected in conjunction with nanobubbles due to the large increase in air/water interfacial area. (This result is unexpected since nanobubbles have a much higher gas pressure inside the bubble than a microbubble, and hence nanobubbles are not usually stable. This will be explained in greater detail below, with reference to the Young-Laplace equation).

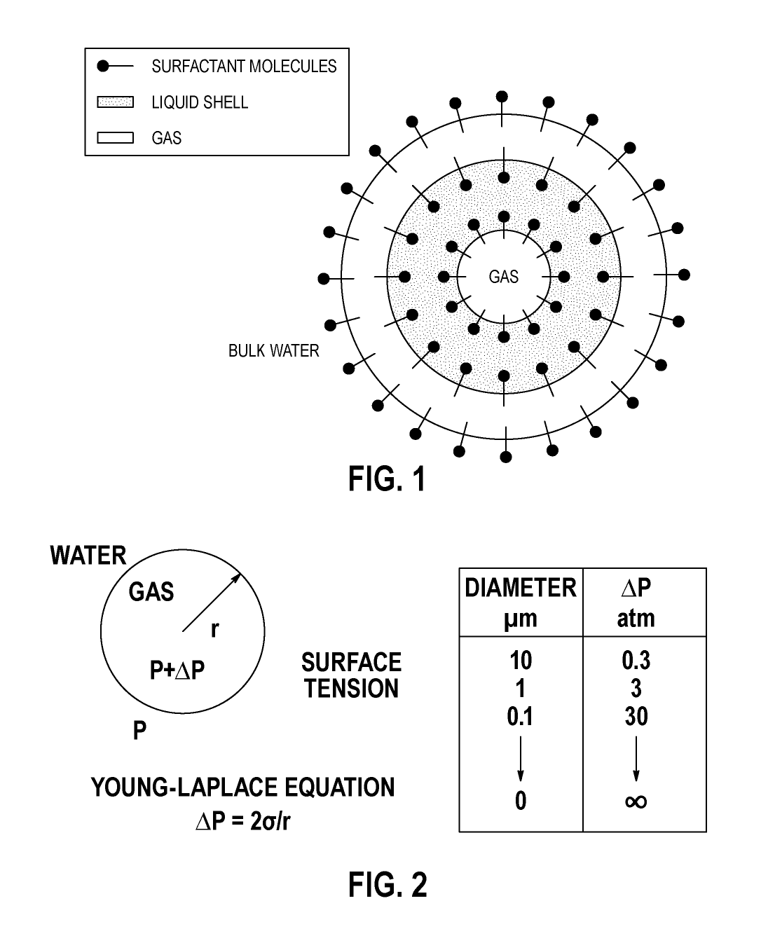

Further, a greater yield of nanobubbles due to the increased solubility of air in water in the presence of the HMP, is a novel feature of the method of the invention. In other words, greater amounts of air can be dissolved in water (than the amounts that can be dissolved when no HMP is present. Without being bound to any theory, it is believed this is because, by using polymers, the nanobubble walls become stronger, because the wall of each nanobubbles is formed with a bi-layer structure, as shown in FIG. 1. This structure allows a higher pressure within the nanobubble and hence larger amounts of gas can be dissolved within each nanobubble. This phenomenon also leads to greater stability of the nanobubbles within the water.

Also the size of the nanobubbles decreases because smaller bubbles can have (can withstand) a higher gas pressure inside the bubble. Typically, bubbles are formed without HMP, and thus without a bi-layer structure. As a result, the bubbles are much larger, since they can only withstand a lower air pressure inside and hence smaller bubbles would burst and combine to form larger air bubbles. However, with stronger bubble walls due to the bi-layer structure achieved via the present invention, smaller bubbles are formed, since they can withstand higher air pressures. The increase in gas pressure with bubble size is given by the Young-Laplace equation, shown in FIG. 2.

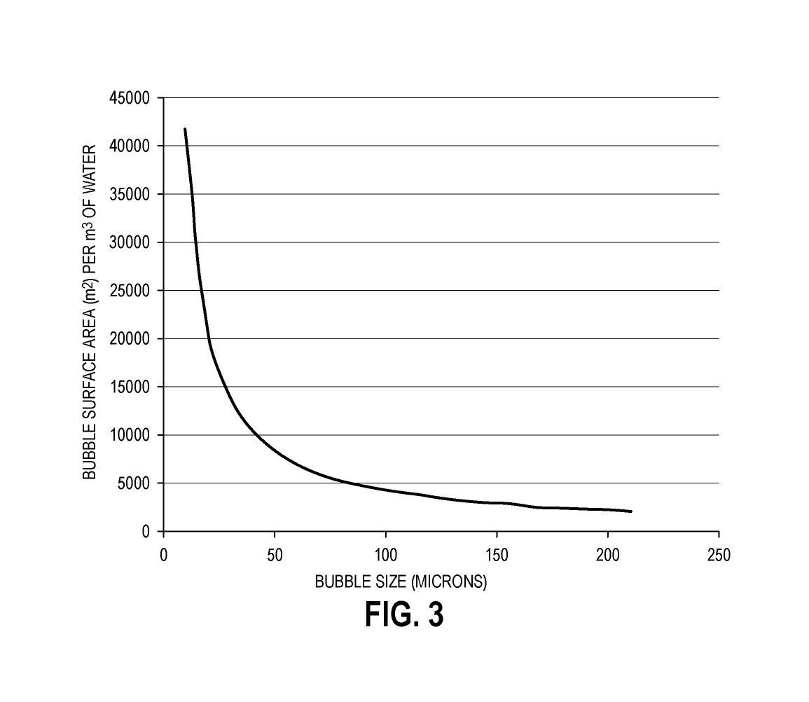

Not only do the methods and other aspects of the present invention allow for smaller bubbles to form (and be stable), but these bubbles also exhibit a greater ability to associate with and remove neutrally-buoyant materials. Smaller nanobubbles exhibit a much larger area of contact with the near neutrally buoyant emulsified oil droplets and gels, as shown in FIG. 3. Additionally, the inventors have observed that the stabilized nanobubbles are more effective at flotation of neutrally buoyant materials in liquids than nanobubbles formed without HMP, due to the ability of the HMP to associate with the neutrally buoyant material to be separated. And, HMP leads to nanobubbles having a greater stability than nanobubbles not associated with HMP.

Nanobubbles are by nature slightly hydrophobic due to their surface curvature, so they would not attach as well to hydrophobic molecules, such as droplets of oil. Gels used in fracking are hydrophilic, and they will not be removed as well also, since the nanobubbles are not highly hydrophilic either. The HMP, however, helps to increase the hydrophobicity of the nanobubbles, as well as increase their capacity to reach these near neutrally buoyant emulsified oil droplets and gels, because nanobubbles with large molecular chains sticking out have a much larger surface area of sweep within the water than just nanobubbles rising through water.

In various embodiments, useful HMP may include any water soluble polymer, wherein the polymer has a minor amount of covalently attached hydrophobic moieties. In various embodiments, the polymer may be synthetic, naturally occurring, or a synthetically modified naturally occurring polymer. In various embodiments, the polymer is linear, branched, hyperbranched, or dendritic. In embodiments, the hydrophobic moieties are bonded to the HMP in amounts of about 0.01 wt % to 5 wt % based on the dry weight of the HMP, or about 0.05 wt % to 2 wt % based on the dry weight of the HMP, or about 0.1 wt % to 1 wt % based on the dry weight of the HMP. In some embodiments, the hydrophobic moiety is present within the polymer backbone, whether randomly dispersed or present in the form of blocks. In other embodiments, the hydrophobic moiety is an endgroup, and is present substantially only at the termini of a polymer; thus, in such embodiments where a linear polymer is employed, a maximum of two hydrophobic moieties are present per polymer chain. In other such embodiments, branched, hyperbranched, or dendritic polymers are capable of having more than two such terminal hydrophobic moieties.

In some embodiments, the hydrophobic moieties are pendant to the polymer backbone. Pendant moieties are either grafted to the polymer backbone, or present as the result of copolymerization. Such grafting or copolymerization is, in various embodiments, random or blocky. In some such embodiments, pendant hydrophobic moieties are incorporated into the polymer via copolymerization at about 0.01 mole % to 1 mole % of the repeat units of the polymer. Pendant hydrophobic moieties are easily incorporated, for example, by copolymerization of water soluble and hydrophobic vinyl monomers. In embodiments, acrylic acid, methacrylic acid, acrylate salts, or methacrylate salts (collectively, acrylates); and acrylamide and methacrylamide (collectively, acrylamides) are water soluble monomers. These monomers are suitably copolymerized with acrylate esters, methacrylate esters, or N-functional acrylamide, N,N-difunctional acrylamide, N-functional methacrylamide, or N,N-difunctional methacrylamide monomers having hydrophobic moieties present as the ester or N-functional group(s). In such embodiments, examples of useful hydrophobic moieties include linear, cyclic, or branched alkyl, aryl, or alkaryl moieties having between 6 and 24 carbons; perfluorinated or partially fluorinated versions of these moieties, and fluorinated alkyl groups having one or more heteroatoms, including perfluoroalkylsulfonamidoalkyl moieties; dialkylsiloxane, diarylsiloxane, or alkylarylsiloxane moieties having between 3 and 10 siloxane repeat units; and the like. In some embodiments, dodecyl, perfluorooctyl, or dimethyltrisiloxane moieties are useful and effective hydrophobic groups. In some embodiments, an HMP is synthesized from acrylamide and 1 mole % or less of dodecylacrylamide, N,N-dihexylacrylamide, or dodecylmethacrylate, or dodecylacrylate.

Techniques employed to achieve copolymerization of acrylate or acrylamide based HMPs are well documented in the literature, and thus are well known to those of ordinary skill in the relevant art. Typically, emulsion polymerization in a bulk water phase is accomplished using free radical initiators activated by heat or UV irradiation at a specific range of wavelengths; redox polymerization is also conveniently accomplished in some embodiments. Representative examples of suitable emulsion polymerization methodology are described in Schulz, D. and Glass, J., eds., Polymers as Rheology Modifiers, ©1991 American Chemical Society, p. 191; and Glass, J., ed., Polymers in Aqueous Media, © 1989 American Chemical Society, pp. 399-410 (incorporated by reference herein in their entireties). One of skill will readily understand how to vary these methods to form high polymers using acrylate or acrylamide monomers in emulsion polymerization schemes.

Acrylamide or methacrylamide based HMP are, in some embodiments, partially hydrolyzed to form some of the corresponding carboxylate salt after synthesis; copolymerization of acrylate salts with acrylamide or methacrylamide results in the same end product. In embodiments where the anticipated end use of the HMP is in water having significant amounts of electrolytes (including NaCl), acrylamide based copolymers are particularly useful, because acrylamides are less sensitive to the presence of electrolytes in water than are acrylate salts. In such embodiments, it is also desirable to avoid hydrolysis of the acrylamide moieties.

Some representative examples of other useful HMP include hydrophobically modified cellulose, hydrophobically modified hydroxyethylcellulose, hydrophobically modified chitosan, ethoxylated urethane polymers having hydrophobic endgroups, hydrophobically modified starch polymers such as starches from plants including potatoes, corn, and the like. Also useful as alternatives to hydrophobically modified polymers are naturally occurring polysaccharide thickeners such as xanthan gum, locust bean gum, guar gum, and the like. Where hydrophobically modified, examples of useful hydrophobic moieties for modification of polymers include linear, cyclic, or branched alkyl, aryl, or alkaryl moieties having between 6 and 24 carbons; perfluorinated or partially fluorinated versions of these moieties, and fluorinated alkyl groups having one or more heteroatoms, including perfluoroalkylsulfonamidoalkyl moieties; dialkylsiloxane, diarylsiloxane, or alkylarylsiloxane moieties having between 3 and 10 siloxane repeat units; and the like. Again, methods that can be used to associate molecules with one another are well known to those of ordinary skill in the art, and so the use of such methods to associate HMP with nanobubbles will be readily understood by those of ordinary skill in the art.

Effective amounts of HMP employed in water will vary depending on the type of HMP and, to some extent, the gas or gaseous mixture employed. Optimization of HMP amount will be readily deduced by one of skill by observing the amount of the desired gas or gaseous mixture that is entrained in the water at a selected pressure. In some embodiments, the optimization centers around entraining the maximum amount of gas into the water. In other embodiments, the optimization is a balance of entraining more gas without using large amounts of polymer that can act as a contaminant when employed in an application. In some embodiments, the amount of HMP employed is about 0.001 wt % to 3 wt %, or about 0.01 wt % to 1 wt % in water. In some embodiments where the gaseous mixture is air and the HMP is a copolymer of acrylamide and a hydrophobically functionalized acrylate ester or N-functional acrylamide, 0.01 wt % to 0.5 wt % HMP in water, or 0.02 wt % to 0.1 wt % HMP in water is employed to facilitate.

Regarding examples of methods to be used for the optimization of the amount of HMP useful for a particular application: The amount of HMP may be based on the amount of neutrally buoyant contaminant (e.g., gel or emulsified oil) that is present in the second liquid (and which is measureable). In this embodiment, then, the amount of dissolved gas that is converted into nanobubbles is based on the amount of emulsified oil/gel. Since the solubility of air in water increases with pressure, the water flow needed to dissolve the required amount of air that is needed to be formed into nanobubbles can be determined. For example, the saturation concentration of air in water at 1 atm and 25 deg C. is 0.000219 lbs of air/gallon of water. If the pressure used to dissolve more air at the higher pressure is 100 psig or 114.7 psia, then the theoretical air released when the pressure of water saturated with air at 114.7 psia is decreased to 14.7 psia or 1 atm will be equal to 0.000219 lbs of air/gallon of water×((114.7/14.7)−1)=0.0015 lbs of air/gallon water. If the amount of air needed to be converted to nanobubbles is 0.0105 lbs of air/min, then the flow of water needed is 0.0105/0.0015=7 gallons per minute. A person of ordinary skill in the art would readily understand how to use such calculations to optimize the method herein. Further, one does not want to use pressure above the maximum pressure that can be achieved by an air compressor being used, (which in certain compressors may be about 100 psig).

The means of dissolving or dispersing HMP in water are widely described in the literature, and thus well known in the art; for commercially obtained HMP, directions specific to the polymer are often provided to enable one of skill to dissolve or disperse the polymer satisfactorily. For example, for some HMP, it is necessary to use chilled water to obtain a fully dispersed polymer when starting from a dried product. In some embodiments, HMP are ideally used directly from the emulsion employed to facilitate the polymerization; this avoids what can be a time consuming dissolution process and instead amounts to a simple dilution. In some embodiments, mixing, tumbling, shaking, or sonication is useful to facilitate dispersion. Again, the methods for dispersion may be dependent on the selected HMP, and are well known to those skilled in the art.

The solution of HMP in the first liquid is, in some embodiments, a solution of HMP in water. In other embodiments, the first liquid is a mixture of water and a second liquid. In still other embodiments, the first liquid is a liquid or mixture of liquids that does not include water.

The amount of gas pressure applied to the first liquid is not particularly limited and is selected by one of skill based on the targeted application, equipment employed, and the like. The greater the pressure, the greater the amount of gas dissolved in the first liquid; and the greater the number of nanobubbles that can be achieved upon release of the pressure. In many embodiments, the amount of pressure employed is limited by equipment capabilities or safety considerations. For example, for safety considerations, the maximum pressure may be limited to below 100 psia which is a typical maximum pressure for certain air compressors.

The amount of time required to achieve a saturated or nearly saturated solution of the selected gas or gaseous mixture is, in practicality, a function of the ratio of surface area to volume for the first liquid during exposure to the pressurized gas. For example, in some embodiments, the first liquid is placed in a tank or vessel, the vessel is sealed, and pressurized gas is applied to the vessel. In such embodiments, pressure is typically applied for a period of time reach the maximum amount of dissolved gas at the selected pressure, as is easily determined by one of skill using conventional techniques. In some such embodiments, the first liquid is stirred or agitated to increase the rate of dissolution. In still other embodiments, the first liquid is delivered through a fine spray nozzle into a chamber in which compressed gas is stored. In such embodiments, the maximum dissolution of gas is typically entrained during the spraying. One of skill will appreciate that in any such embodiment, the ratio of surface area to volume ratio of the first liquid during exposure to the pressurized gas will determine the amount of time required to reach a saturated solution of the gas in the first liquid; and that the amount of time required is easily determined for a given apparatus, makeup of the first liquid, etc.

Such techniques to dissolve a gas in the first liquid are also useful for dissolving gases in various types of liquids and mixtures employed as the first liquid. The liquid is, in various embodiments, water, an organic liquid having between 1 and 8 carbons, or an aqueous solution of water and a water soluble organic liquid. Examples of suitable water soluble organic liquids include alcohols, such as methanol, ethanol, or propanol; amines such as ethylamine, diethanolamine, triethanolamine, and the like; ketones, such as acetone or methyl ethyl ketone; aldehydes, such as formaldehyde, acetaldehyde, and the like; and other organic compounds; or mixtures thereof. In many embodiments, the first liquid is water or water with an HMP dissolved or dispersed therein.

### 3. RELEASE OF NANOBUBBLES FOR FLOTATION

Once the selected amount of gas or gaseous mixture is entrained in the first liquid, the pressurized first liquid, or pressurized solution, is deployed in one or more applications where nanobubbles are released. Upon gradient depressurization of the pressurized solution, nanobubbles will form. In many embodiments, depressurization is desirably carried out during delivery of the first liquid to a second liquid, where the nanobubbles will form and achieve association with, and thereby flotation of, neutrally buoyant materials (e.g. debris, oily dispersed materials, and the like). In such applications, it will be appreciated that the pressurized solution is effectively a nanobubble “concentrate” wherein the amount of bubbles formed upon release of pressure is suitable for flotation of neutrally buoyant materials in a much larger volume of liquid (i.e., the second liquid). Thus, one aspect of a method of the invention is the contemporaneous gradient or stepwise release of pressure, and dilution in a vessel containing a second liquid and neutrally buoyant material. However, the methods of the invention are not limited to contemporaneous release of pressure and dilution; thus, in some embodiments, gradient release of pressure and dilution are suitably carried out in separate steps (in those other embodiments then, nanobubbles are first formed and then introduced into a second liquid, rather than being formed during contact within the second liquid).

The gradient release of pressure of the pressurized solution results in the formation of nanobubbles. The nanobubbles are formed in conjunction with contact of the pressurized solution with a second liquid that is maintained at a lower pressure than the pressurized solution, wherein the gradient pressure change results in the first liquid contacting the second liquid and reaching a final pressure that is the pressure of the second liquid. In embodiments, the gradient release of pressure is accomplished using conventional equipment designs that provide control of pressure release. For example, in embodiments, the gradient release of pressure is accomplished by delivering the first liquid into a larger vessel filled with the second liquid, wherein the delivery is via Venturi eductor, that is, a converging-diverging nozzle that converts the pressure energy to velocity energy, wherein the low pressure zone formed by the velocity energy of the first liquid serves to pull in an amount of the second liquid, and the combined liquids are ejected from the eductor into the vessel containing the second liquid. In other embodiments, the first liquid is introduced into a series of chambers, wherein each chamber has a slightly lower pressure therein, and the first liquid is eventually released into the vessel containing the second liquid.

As described above, the nanobubbles may be of a particular size, or within a range of size. The size of the nanobubbles depends on at least two factors: (1) gradient release of pressure, which ensures that smaller bubbles form; and (2) increased nanobubble stability, which depends on the bubble wall being able to withstand the higher air pressure inside the nanobubble. If the liquid pressure is released abruptly, then larger bubbles would form, since the bubbles would grow to accommodate the air that is coming out of solution due to pressure. And, if there are no HMPs or surfactants, smaller bubbles form, which then burst and coalesce into larger bubbles.

In embodiments, the second liquid is maintained at ambient pressure, that is, 0.101 MPa or 1 atm. In other embodiments, the second liquid is maintained at a pressure that is higher or lower than ambient pressure. The second liquid must be maintained at a pressure that is lower than the pressure applied to the pressurized solution, wherein the pressure differential is sufficient to result in the formation of nanobubbles when a gradient pressure release is carried out and the first liquid is contacted with the second liquid. In embodiments, the pressure differential between the pressurized solution and the second liquid is at least 0.1 MPa, such as between 0.1 MPa and 1 MPa, or between 0.3 MPa and 0.8 MPa.

In certain embodiments, the dilution of the pressurized solution is selected based on the nature of second liquid, the type and amount of the neutrally buoyant material to be addressed, and the amount of pressure applied to the first liquid to form the pressurized solution. Where the first liquid is water containing an HMP and the second liquid is produced water that is hard water or brackish water containing an oily mixture as the neutrally buoyant material, the dilution factor for HMP/water mixtures described above, pressurized at about 0.6 MPa, the dilution factor ranges from about 30:1 to 5:1 vol:vol [water]:[pressurized HMP/water], or about 30:1 to 10:1 vol:vol [water]:[pressurized HMP/water], or about 25:1 to 10:1 vol:vol [water]:[pressurized HMP/water].

Each of these processes, i.e. pressurizing the first liquid, dilution of the first liquid with the second liquid, and pressure release of the pressurized solution are, in various embodiments, accomplished in continuous feed or in single batch mode.

### 4. APPARATUS AND METHOD USEFUL FOR SEPARATION OF NEUTRALLY BUOYANT MATERIALS

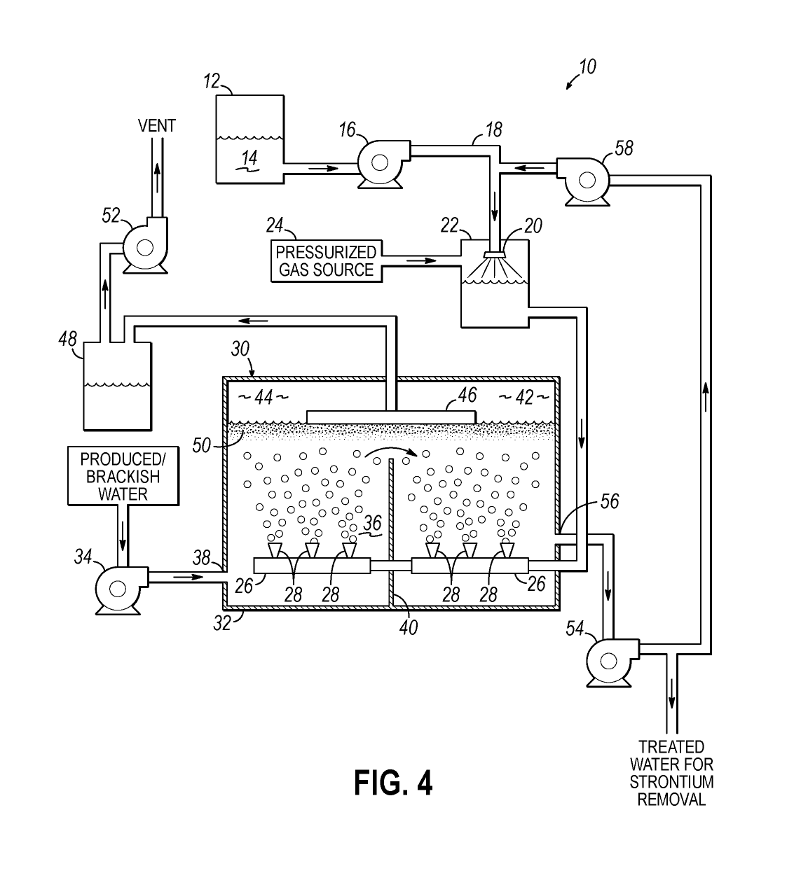

FIG. 4 shows one embodiment of an apparatus 10 of the invention. The apparatus enables the formation of nanobubbles and use thereof to separate a neutrally buoyant material from a liquid. In some embodiments, the liquid is water. In some such embodiments, the water is produced water. In some embodiments the neutrally buoyant material is an oily mixture.

In the embodiment of the apparatus 10 shown in FIG. 4, a holding tank 12 contains a solution or dispersion of HMP in water 14. The HMP/water solution 14 is pumped via pump 16 via path 18 to spray head 20, and is sprayed by spray head 20 into pressurized tank 22. Pressurized tank 22 is maintained at elevated pressure by pressurized gas source 24. Pressurized gas source 24 contains a gas or a mixture of gases that is selected by the user, wherein the gas or mixture of gases is present at elevated pressure. One example of an apparatus that comprise the pressurized gas source 24 is an air compressor. In some embodiments, the pressurized gas source 24 is in equilibrium with the pressure in the pressurized tank 22. In other embodiments, the pressurized gas source 24 is maintained at a higher pressure than pressurized tank 22, and the pressure is stepped down by a pressure regulator, valve, or other suitable apparatus (not shown) disposed between pressurized gas source 24 and pressurized tank 22. In embodiments, the elevated pressure range for pressurized tank 22 is about 0.102 MPa (1.01 atm) to 2.03 MPa (20 atm), or about 0.203 MPa (2 atm) to 1.52 MPa (15 atm), or about 0.507 MPa (5 atm) to 1.01 MPa (10 atm). A pressure range for the pressurized tank 22 to operate may be 14.7 to 200 psia. At the higher operating pressures, significant amounts of air can be dissolved into the water. The pressurized tank 22 also serves as a holding tank for a solution or dispersion of HMP in water 14 that is saturated with gas from pressurized gas source 24.

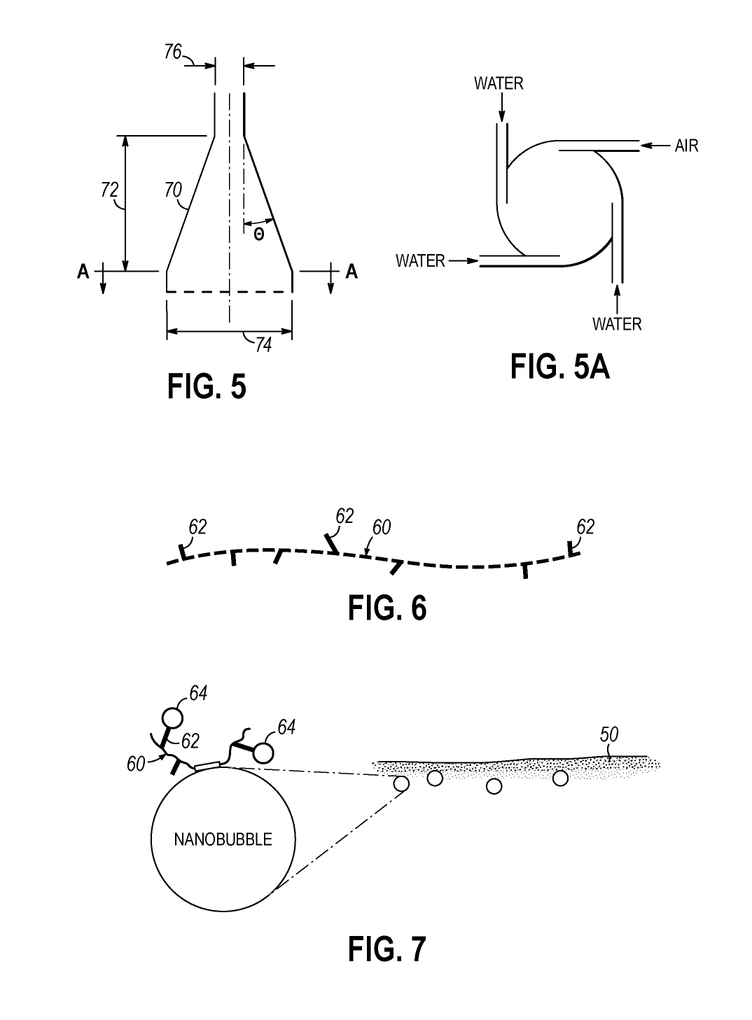

The pressurized HMP/water solution 14 flows from the pressurized tank 22 into a header 26 having eductors 28. As is known to those of ordinary skill in the art, an educator is a type of pump that uses the Venturi effect of a converging-diverging nozzle to convert the pressure energy of a motive fluid to velocity energy which creates a low pressure zone that draws in and entrains a suction fluid. An example of a nozzle that can be used to make the nanobubbles is shown in FIG. 5 and FIG. 5A. After passing through the throat of the injector, the mixed fluid expands and the velocity is reduced which results in recompressing the mixed fluids by converting velocity energy back into pressure energy. Referring back to FIG. 4, the header 26 and eductors 28 are disposed within a vessel 30, and may be (in certain embodiments) further situated at or near the bottom 32 thereof. A pump 34 pumps a liquid 36 into the vessel 30 via an inlet 38 situated near the bottom 32 of vessel 30. The liquid may be water containing a neutrally buoyant material that one wishes to separate and remove from the water. During operation of the apparatus 10, header 26 and eductors 28 are fully immersed in the liquid. Vessel 30 may also have a baffle 40 partitioning vessel 30 into first and second compartments 42, 44 such that the liquid entering vessel 30 enters vessel 30 via first compartment 42 and must flow over baffle 40 to reach second compartment 44. Header 26 passes through baffle 40 and is in fluid connection with eductors 28 and pressurized tank 22.

FIG. 5 and FIG. 5A show one implementation of the above principle of achieving a reduced pressure gradient is to introduce gas and liquid simultaneously and tangentially into a conical cylinder, as shown in FIG. 5 and FIG. 5A, which generates a high speed rotational flow. The nozzle 70 includes a conical section length 72 and a base width 74 and a nozzle exit width 76. The centrifugal force forces the liquid in the outer circle of the flow rotation, gas and liquid flows in the concentric space between the outside liquid flow and the inner gas core. The friction between the swirling layers creates the nanobubbles of the gas in the liquid, as the gas-liquid mixture flows out of the nozzle.

Experiments were conducted with a conical test section, shown in FIG. 5 and FIG. 5A. The flow of water and air were measured by rotameters. The volumetric fluxes of the water and gas are determined as follows:

[J_{L}]=Q_{L}/A and [J_{G}]=Q_{G}/A where QL and QL are liquid and gas flowrates in m³/s, and A is the cross-sectional area of the cone in the entrance region of the nozzle, i.e., A=pDo²/4, where Do is the diameter of the entrance cone. The liquid volumetric flux, [J_{L}] is kept below 0.2 m/s and the gas volumetruic flux [JG] is kept below 0.03 m/s. In this regime of gas-liquid flow, the gas forms nanobubbles due to the gradual loss of pressure, as the rotational flow moves from the entrance region to the outlet part of the nozzle.

Referring again to FIG. 4, vessel 30 may be maintained at ambient pressure. As liquid 36 is pumped by pump 34 into inlet 38 near the bottom 32 of vessel 30, the HMP/water solution 14, under pressure and containing dissolved gas from pressurized gas source 24, is released by eductors 28 into vessel 30 at or near the bottom 32 thereof. As the pressure within pressurized tank 22 and header 26 is released, nanobubbles form. As the HMP/water solution 14 is forced out of each eductor 28 by the pressure from pressurized tank 22, it draws in a portion of liquid 36 from the vessel 30 and creates a well-mixed stream that flows out from the top of each eductor 28. The mixing contributes to a well-dispersed stream of HMP nanobubbles that flow from eductors 28 and float generally toward skimmer 46.

As the nanobubbles progress from eductors 28 toward skimmer 46, they interact with neutrally buoyant material present in the liquid 36 pumped into vessel 30, and cause flotation of the neutrally buoyant material (as described above), thereby separating the neutrally buoyant material from the liquid. The decrease of pressure of the HMP/water solution 14 to almost atmospheric pressure, coupled with good mixing achieved by the eductor 28, creates a swarm or cloud of nanobubbles within vessel 30. The nanobubbles, having higher surface area than larger bubbles, act to separate even very finely divided and dispersed neutrally buoyant materials from the liquid in vessel 30. The nanobubbles in the presence of HMP further exhibit enhanced ability to separate such neutrally buoyant material from liquids, as described above.

Also disposed within vessel 30 is skimmer 46, as mentioned above. Skimmer 46 is situated in a floating and variable level configuration, in contact with the surface of the liquid within the vessel 30 and is connected to collection vessel 48. Skimmer 46 contacts the surface of the liquid in vessel 30 and suctions a surface layer 50 therefrom. The suctioned surface layer 50 is deposited into collection vessel 48. Suction is provided by a vacuum pump or other suction means 52, which is attached to collection vessel 48. Skimmer 46 removes surface layers from both first and second compartments 42, 44 of vessel 30. Liquid from compartment 44 may be removed from the vessel 30 by pump 54 through outlet 56. Pump 54 is, in some embodiments of the invention, connected to one or more additional apparatuses (not shown). In some such embodiments, the one or more apparatuses are designed and situated for further purification or processing of the liquid. In other embodiments, liquid is removed from compartment 44 by pump 54 through outlet 56 to a tank or other holding apparatus (not shown). Additionally, some treated water is pumped by pump 58 into the spray head 20, located in the pressurized tank 22, and air dissolves in the water at the higher pressure.

In some embodiments of apparatus 10 or alternative embodiments thereof as described herein, the liquid pumped into vessel 30 by pump 34 is produced water. In some such embodiments, the neutrally buoyant material is an oily mixture. In some embodiments, the liquid removed by pump 54 is brackish water. In some embodiments, the liquid removed by pump 54 is hard water.

Thus, FIG. 4 shows the implementation of an air nanobubble embodiment using hydrophobically modified polymers to enhance the attachment of the nanobubbles to the emulsified oil droplets and to the floating oil layer (or other neutrally buoyant material), to enhance the density difference between the oil/gel/clay/sand/silt sludge and the water, containing a high concentration of dissolved salts.

FIG. 4 shows one embodiment of an apparatus of the invention. Alternative embodiments are envisioned, as will be readily understood by one of skill. For example, in some embodiments, the HMP/water solution or dispersion in holding tank 12 is connected directly to pressurized gas source 24, and there is no spray head 20 or separate pressurized tank 22. Instead, in such embodiments, holding tank 12 is also a pressurized tank, and the pressurized gas is allowed to saturate the HMP/water solution or dispersion 14 as it resides in the tank 12. In some such embodiments, pressurized gas source 24 is connected to holding tank 12 at the bottom thereof, and the gas within pressurized gas source 24 is bubbled through the HMP/water solution or dispersion in holding tank 12. In other such embodiments, holding tank 12 may have a means of agitation, such as an impeller or other stirring mechanism, and the contents of the tank are stirred to increase the rate of gas saturation of the HMP/water solution or dispersion.

In the illustrated embodiment of FIG. 4, there are two compartments 42, 44 in vessel 30. In other embodiments of the apparatuses of the invention, three, four, five, or more compartments are advantageously employed, wherein each compartment is a further division of vessel 30 separated by a baffle 40 and wherein each compartment has at least one eductor 28 or other means present to dispense nanobubbles, and a skimming apparatus such as skimmer 46. Addition of more compartments in this manner causes additional separation steps, which in turn results in a greater yield of separated neutrally buoyant materials from the liquid provided to vessel 30.

Further, in the illustrated embodiment of FIG. 4, there are three eductors 28 in each compartment 42, 44. It will be appreciated that in various embodiments of the apparatuses of the invention, the eductors 28 are present in varying numbers and locations as dictated by the size and dimensions of the vessel 30, shape of header 26, volume of liquid having neutrally buoyant material, and type and amount of neutrally buoyant material encountered in the application. However, at least one eductor 28 is required. Where only one eductor 28 is present, the eductor 28 may be disposed within compartment 42.

In some embodiments, instead of eductors 28 as shown in apparatus 10, an alternative means of introducing pressurized HMP/water solution into vessel 30 is employed. For example, spray heads, needle injectors, and the like are employed in some embodiments.

Before the water is sprayed as described above and shown in FIG. 4, a hydrophobically modified polymer may be added in small amounts to the water using pump 16 and this polymer liquid is stored in vessel 12. This hydrophobically modified polymer, which is soluble in water, goes into solution, and when the water is bubbled through the eductors in vessel 30, nanobubbles of air are created due to decreased pressure, and the hydrophobically modified polymer spontaneously partitions at the air-water interface.

This hydrophobically modified polymer is basically a hydrophilic backbone with side chains that are hydrophobic. Examples of hydrophobically modified polymers includes acrylamide copolymers, partially hydrolyzed polyacrylamide (HPAM) or biopolymers such as xanthan or guar gum. Typically, these polymers are water soluble polymers that contain a small number (less than 1 mole %) of hydrophobic groups attached directly to the polymer backbone. FIG. 6 shows a schematic of a hydrophobically modified polymer (dotted line) 60 with hydrophobic groups 62 (shown as dark line segments), attached directly to the polymer backbone. Referring to FIG. 6 and FIG. 7, when these hydrophobically modified polymers are present in water which has air bubbles, these polymers partition at the air/water interface of each bubble spontaneously, with some hydrophobic groups exposed to the water, as shown in FIG. 6 and FIG. 7. These hydrophobic groups are instrumental in increasing the hydrophobicity of the nanobubbles and allowing these nanobubbles of air to attach to oil droplets 64 emulsified in the water and to the oil layer (as the oil is likewise hydrophobic), as also shown in FIG. 6 and FIG. 7. By allowing this large number of nanobubbles into the oil, the density difference between the oil and water is increased substantially allowing the oil to separate from the water faster than otherwise.

Additional equipment added to the apparatus to facilitate continuous or batch operation thereof include various gauges, valves, balances, flow regulators, pressure regulators, pumps, controlling and automation equipment including hardware, firmware, and software employed to monitor and control the apparatus, baffles, stratified flow features, weirs, level sensors, temperature sensors, and the like. For example, in some embodiments an apparatus similar to that shown in FIG. 4 will include a source of hydrophobically modified polymer in a substantially dry state or a highly concentrated state in water, a source of pure water, and means to mix the HMP and water in a selected ratio prior to introduction to holding tank 12. In some embodiments where the liquid from the outlet 56 is water, a similar mixing setup will include a fluid connection between outlet 56 and the mixing apparatus wherein a portion of the liquid exiting vessel 30 is partitioned from the outlet and directed into holding tank 12 to be blended with the HMP. Such a setup negates the need for an additional source of pure water.

### 5. RESULTS OF SEPARATING NEUTRALLY BUOYANT MATERIALS

Association of and/or interaction of the neutrally buoyant materials with the nanobubbles decreases the overall density of the neutrally buoyant materials attached to nanobubbles (i.e., the combined material/nanobubble density) and allows the neutrally buoyant materials to separate from the liquid by floating toward the surface of the liquid at a higher rate than without the nanobubbles. Combining the use of nanobubbles with HMP allows the neutrally buoyant materials to rapidly rise through the liquid to the surface where they can be easily skimmed off using conventional skimming operations. Due to the large number of nanobubbles and large gas/liquid interfacial area imparted by the use of nanobubbles, it is a feature of the method of the invention that the resulting increased interaction of bubble interfacial area with finely dispersed, unagglomerated phase separated neutrally buoyant materials are contacted with the nanobubbles in sufficient amounts to effectively and efficiently separate even these materials from the liquid. Thus, for example, finely divided emulsified or gelled oily materials dispersed in produced water from a mining operation are effectively separated from produced water by use of the methods of the invention.

Without wishing to be limited by theory, it is believed that the presence of HMP in the water used to form the nanobubbles enhances the interaction of the nanobubbles with the phase separated neutrally buoyant materials to result in a greater yield of total removed phase separated neutrally buoyant materials than the observed degree of separation observed when nanobubbles are formed from deionized-distilled water or solutions of water without HMP. Additionally, judicious selection of HMP structure and chemistry provides an enhanced means to remove neutrally buoyant materials from hard water or brackish water. For example, as described above, where the liquid containing neutrally buoyant materials is water having electrolytes dissolved therein, such as brackish water, it is desirable to select a nonionic HMP such as a polyacrylamide based HMP to avoid the collapse of the HMP from solution when contacted with the electrolyte-bearing water having neutrally buoyant materials dispersed therein.

Where HMP facilitated nanobubbles are employed, the yield of separated neutrally buoyant materials is greater than the yield realized by using conventional bubbles or even nanobubbles formed in the absence of HMP. Yield of separated neutrally buoyant materials is calculated as the weight percent of the total weight of neutrally buoyant materials from the liquid that is present at the surface of the liquid in a sufficiently stable separated layer for removal by conventional apparatuses such as skimmers. In various embodiments, between 75% by weight and 100% by weight of the total amount by weight of neutrally buoyant materials are separated from liquid using the HMP facilitated nanobubble flotation methods described above. In some embodiments where the liquid is produced water and the neutrally buoyant material is an oily mixture, between about 80 wt % and 100 wt % of the oily mixture present in the produced water is separated, or between about 90 wt % and 99.9 wt % of the oily mixture present in the produced water is separated, or between about 95 wt % and 99 wt % of the oily mixture present in the produced water is separated, or between about 97 wt % and 99 wt % of the oily mixture present in the produced water is separated, or between about 97 wt % and 99.9 wt % of the oily mixture present in the produced water is separated.

### 6. APPLICATION TO PRODUCED WATER FROM HYDROFRACTURING

In some embodiments, nanobubble facilitated separation is employed as a first step in the remediation of produced water from mining operations. In some such embodiments, the produced water contains a significant amount of dissolved ferrous ions, for example about 2 mg/mL to 3000 mg/mL of ferrous ions. Ferrous ions are undesirable in water due to staining (when ferric salts form during subsequent treatment or use) and fouling of water remediation apparatuses such as ion exchange resins and filtration membranes. Ferrous ions are soluble in water and are not phase separated.

In such embodiments, an additional benefit of the methods and apparatuses of the invention is realized by employing air, air enriched with oxygen, or another gas mixture including oxygen, to pressurize the HMP/water solution. By employing an oxygen-containing gas to pressurize the HMP/water solution and subsequently releasing the pressurized solution into the produced water as described above, the oxygen reacts with the ferrous ions in the water to form ferric salts, which are insoluble in water. Because of the large amount of gas-water interface area provided by the nanobubbles, oxidation is efficient and in embodiments even up to 3000 mg/mL of ferrous ions are converted to insoluble ferric salts during the separation of oily mixtures from the water. Further, the nanobubbles also cause flotation of the ferric salts as they form, effectively separating them from the produced water. This is a benefit in the overall remediation of water, and is a further benefit in embodiments where further water remediation equipment is located downstream from the oily mixture separation apparatus, since removal of the ferric salts avoids fouling of filtration membranes and ion exchange resins and deposition of ferric salts on other pipes and equipment.

In embodiments, between about 75 wt % and 100 wt % of the ferrous ions present in the produced water are removed by employing the apparatuses and methods described above, wherein the gas employed to form the nanobubbles contains at least about 20% oxygen. In other embodiments, between about 85 wt % and 99 wt % of the ferrous ions present in the produced water are removed, or about 90 wt % to 98 wt % of the ferrous ions present in produced water are removed. Enriching the oxygen content of air, for example, or increasing the amount of nanobubbles dispensed in a given volume of produced water—for example by adding more eductors 28 to apparatus 10 of FIG. 4 or by adding additional compartments to the vessel 30 as discussed above—are methods that will increase the amount of oxidation and separation of ferrous ions from water as will be readily appreciated by one of skill.

The present invention may suitably comprise, consist of, or consist essentially of, any of the disclosed or recited elements. As used herein, the term “consisting essentially of” does not exclude the presence of additional equipment or materials which do not significantly affect the desired characteristics, properties, or use of a given composition, product, method, or apparatus. The invention illustratively disclosed herein can be suitably practiced in the absence of any element which is not specifically disclosed herein. The various embodiments described above are provided by way of illustration only and should not be construed to limit the claims attached hereto. It will be recognized that various modifications and changes may be made without following the example embodiments and applications illustrated and described herein, and without departing from the true spirit and scope of the following claims.

We claim:

1. A method of separating a neutrally buoyant material from a liquid, the method comprising
(a) pressurizing a first liquid with a gas at a first pressure to form a pressurized liquid; and
(b) contacting the pressurized liquid with a second liquid, the second liquid including a neutrally buoyant material dispersed therein, the second liquid being maintained at a second pressure that is lower than the first pressure,
wherein the contacting includes a gradient pressure change from the first pressure to the second pressure, such that the gradient pressure change results in the formation of nanobubbles having an average diameter of about 10 nm to 100 nm.

2. The method of claim 1 wherein the first liquid includes a hydrophobically modified water soluble polymer dispersed or dissolved therein.

3. The method of claim 2 wherein the hydrophobically modified water soluble polymer comprises repeat units derived from monomers including acrylamide, acrylate, methacrylate, or combinations thereof.

4. The method of claim 1 wherein the neutrally buoyant material is oil or an oily mixture.

5. The method of claim 1 wherein the pressure difference between the first pressure and the second pressure is about 0.1 MPa to 1 MPa.

6. The method of claim 1 wherein the second pressure is about 0.101 MPa.

7. The method of claim 1 wherein at least 90 wt % to 100 wt % of the total weight of neutrally buoyant material floats to the surface of the contacted first and second liquids.

8. The method of claim 1, wherein the neutrally buoyant material has an average density that is between about 95% and about 105% of the density of the second liquid.

9. The method of claim 1, wherein the first liquid is chosen from water, an aqueous solution of an alcohol, and a solution of a hydrophobically modified water soluble polymer in water.

10. The method of claim 1, wherein the nanobubbles have a density that is 90% or less of the density of the first liquid.

11. The method of claim 1, further comprising associating a hydrophobically modified water soluble polymer with the nanobubbles, by dispersing a hydrophobically modified water soluble polymer in the first liquid.

12. The method of claim 1, wherein the hydrophobic moieties are incorporated into the polymer via copolymerization at about 0.01 mole % to 1 mole % of the repeat units of the polymer.

13. The method of claim 12, wherein the incorporation includes the copolymerization of water soluble monomers and hydrophobic vinyl monomers.

14. The method of claim 13, wherein the water soluble monomers are chosen from acrylic acid, methacrylic acid, acrylate salts, methacrylate salts, acrylamide, and methacrylamide.

15. The method of claim 14, wherein the water soluble monomers are copolymerized with one or more of acrylate esters, methacrylate esters, N-functional acrylamide, N,N-difunctional acrylamide, N-functional methacrylamide, or N,N-difunctional methacrylamide monomers having hydrophobic moieties present as the ester or N-functional group(s).

16. The method of claim 1, wherein the hydrophobic moieties are chosen from linear, cyclic, or branched alkyl, aryl, or alkaryl moieties having between 6 and 24 carbons; perfluorinated or partially fluorinated versions of these moieties, and fluorinated alkyl groups having one or more heteroatoms, including perfluoroalkylsulfonamidoalkyl moieties; dialkylsiloxane, diarylsiloxane, or alkylarylsiloxane moieties having between 3 and 10 siloxane repeat units; and the like.

17. The method of claim 1, wherein the hydrophobic moieties include dodecyl, perfluorooctyl, or dimethyltrisiloxane moieties.

18. A method of forming nanobubbles, the method comprising
(a) dissolving a hydrophobically modified water soluble polymer in a liquid to form a solution,
(b) pressurizing the solution with a gas to form a pressurized solution, and
(c) reducing the pressure applied to the pressurized solution by employing a gradient pressure change sufficient to form nanobubbles out of solution, the nanobubbles having an average diameter of about 10 nm to 100 nm.

19. The method of claim 18, wherein the hydrophobically modified water soluble polymer comprises repeat units derived from monomers chosen from an acrylamide, an acrylate, a methacrylate, and combinations thereof.

20. The method of claim 18, wherein the hydrophobically modified water soluble polymer has about 0.01 wt % to about 5 wt %, based on the dry weight of the polymer, of hydrophobic moieties covalently bonded to the polymer backbone.

21. The method of claim 20, wherein the hydrophobic moieties covalently bonded to the polymer backbone are pendant from, incorporated within, or present at the termini of the polymer backbone.

22. The method of claim 20, wherein the hydrophobic moieties includes hydrocarbon, siloxane, fluorocarbon, or a combination thereof.

23. The method of claim 18, wherein the hydrophobically modified water soluble polymer includes at least one hydrophobic moiety.

24. The method of claim 23, wherein the at least one hydrophobic moiety is an endgroup, and is present substantially only at the termini of the polymer.

25. The method of claim 18, wherein the hydrophobically modified water soluble polymer includes a minor amount of covalently attached hydrophobic moieties.

26. The method of claim 18, wherein the hydrophobically modified water soluble polymer is chosen from a synthetic polymer, a naturally occurring polymer, and a synthetically modified naturally occurring polymer.

27. The method of claim 18, wherein the hydrophobically modified water soluble polymer is chosen from a linear polymer, a branched polymer, a hyperbranched polymer, and a dendritic polymer.

28. The method of claim 18, wherein the hydrophobically modified water soluble polymer is synthesized from acrylamide and 1 mole % or less of dodecylacrylamide, N,N-dihexylacrylamide, or dodecylmethacrylate, or dodecylacrylate.

29. An apparatus that achieves separation and removal of neutrally buoyant materials from liquid, the apparatus comprising:
a source of pressurized gas;
a pressurized tank situated to receive a pressurized solution of a first liquid, wherein the pressurized tank is connected to the source of pressurized gas;
an element attached to the pressurized tank and adapted to deliver the pressurized solution into a second liquid; and
a receiving vessel for holding the second liquid having a neutrally buoyant material dispersed therein, wherein the element is disposed within the receiving vessel.

30. The apparatus of claim 29, further comprising a skimmer disposed within the receiving vessel and adapted to remove a separated layer from the surface of a liquid present within the receiving vessel.

31. The apparatus of claim 29 wherein the element for delivering the pressurized solution may include one or more headers or one or more eductors.
